(19) United States
(12) Patent Application Publication
(10) Pub. No.: US 2025/0289443 A1
(43) Pub. Date: Sep. 18, 2025

(54) Custom Application System for Safe Vehicle Operation

(71) Applicant: Applied Electric Vehicles Ltd, Scoresby (AU)

(72) Inventor: Marc Alexander, Croydon Hills (AU)

(73) Assignee: Applied Electric Vehicles Ltd, Scoresby, VI (AU)

(21) Appl. No.: 18/606,548

(22) Filed: Mar. 15, 2024

(51) Int. Cl. B60W 50/029; B60W 50/023

(52) U.S. Cl. CPC B60W 50/029; B60W 50/023; B60W 2050/0295

(57) ABSTRACT

A custom application system for safe vehicle operation is described. In one or more implementations, a single electronic control unit (ECU) of a vehicle controls safe operation of the vehicle and also executes applications, e.g., third party applications, within a partition that isolates execution of the applications from components responsible for the vehicle's safe operation. In accordance with the described techniques, the ECU includes a first processor to execute the applications and a second processor to maintain an operating state of the vehicle within a safe operating envelope of the vehicle. The second processor receives requests from the applications executed by the first processor and arbitrates them based on satisfying safety rules for the vehicle.

### BACKGROUND

Vehicle manufacturers encounter numerous challenges when incorporating applications into vehicles, such as with applications from third parties. Examples of those applications include applications for in-vehicle infotainment and climate control, e.g., HVAC, lighting, etc. These challenges primarily revolve around compatibility, safety, security, and user experience. Ensuring seamless integration with the vehicle's hardware and software is critical, yet difficult, as it necessitates compatibility without compromising the vehicle's functionality or user safety. These applications must not only adhere to stringent safety guidelines to protect people and physical property from harm but also meet high standards for cybersecurity to safeguard user data against potential breaches. Moreover, the continuous evolution of software necessitates regular updates and maintenance, posing additional challenges in ensuring that such custom applications do not detract from the vehicle's performance or user experience.

Furthermore, the integration of custom applications introduces complexities in standardization, regulatory compliance, and maintaining a consistent user experience across different platforms. Vehicle makers must navigate a landscape of varying international regulations and strive for a harmonious integration that aligns with the vehicle's design and user interface principles. Addressing these challenges requires a delicate balance between innovation and adherence to safety, privacy, and regulatory standards, all while managing the limited computing resources of the vehicle and ensuring that essential functions remain unaffected. Conventionally, this requires that manufacturers work closely with software developers to ensure these applications enhance the driving experience without undermining vehicle safety, performance, or user privacy.

### BRIEF DESCRIPTION OF THE DRAWINGS

FIG. 1 is a block diagram of a non-limiting example including a vehicle having an architecture to operate the vehicle safely while executing custom applications.

FIG. 2 is a block diagram of a non-limiting example of a vehicle system that implements custom application systems for safe vehicle operation.

FIG. 3 depicts an example implementation of custom application systems for safe vehicle operation.

FIG. 4 depicts another example implementation of custom application systems for safe vehicle operation.

FIG. 5 depicts an example implementation in which an application executed by a custom application system for safe vehicle operation utilizes a human machine interface of a vehicle.

FIG. 6 depicts a procedure in an example implementation of custom application systems for safe vehicle operation.

FIG. 7 depicts another procedure in an example implementation of custom application systems for safe vehicle operation.

FIG. 8 depicts another procedure in an example implementation of custom application systems for safe vehicle operation.

### DETAILED DESCRIPTION

Vehicle manufacturers encounter numerous challenges when incorporating applications into vehicles, such as when incorporating applications from third parties. These challenges often revolve around compatibility, safety, security, and user experience. Ensuring seamless integration with the vehicle's hardware and software is critical, yet difficult, as it necessitates compatibility without compromising the vehicle's functionality or safety. Conventionally, this requires that manufacturers work closely with software developers to ensure these applications enhance the driving experience without undermining vehicle safety, performance, or user privacy.

A custom application system for safe vehicle operation is described herein. In one or more implementations, a single electronic control unit (ECU) of a vehicle controls safe operation of the vehicle and also executes applications, e.g., third party applications, within a partition that isolates execution of the applications from components responsible for maintaining the vehicle's safe operation. The use of a single electronic control unit to safely operate the various subsystems of a vehicle contrasts with conventional approaches that utilize a network of electronic control units distributed throughout vehicles. In those conventional approaches, each subsystem is often operated or controlled by a respective electronic control unit, resulting in vehicles having an electronic control unit per subsystem.

To control safe operation of the vehicle, the described system includes at least one safety processor configured to operate the vehicle so that the vehicle meets or exceeds one or more safety standards, such as Automotive Safety Integrity Level D (ASIL-D). In at least one implementation, the system includes two safety processors configured to operate redundantly, e.g., as if they are both operating the vehicle. For instance, each of the two safety processors makes vehicle control and vectoring decisions as if responsible for operating the vehicle in real-time.

To execute applications without compromising the safety of the vehicle and its surroundings, the described system also includes an application processor that is partitioned from the safety processors. By way of example, the partitioned application processor is a separate hardware component that is physically partitioned from the safety processors. For instance, the partitioned application processor is a processing unit, the two safety processors are implemented using two separate processor cards, and the partitioned application processor is communicatively coupled to the safety processors via physical Ethernet connections. The application processor may be partitioned from the safety processors in additional ways to prevent execution of the applications on the partitioned application processor from affecting the functioning of the safety processors to control safe operation of the vehicle.

As the partitioned application processor executes applications within the partition, those applications may request that subsystems of the vehicle perform various operations, such as operations to provide in-vehicle infotainment, climate control (e.g., HVAC, lighting, etc.), vehicle pod and payload control and management, and vehicle navigation (e.g., as informative and directions to a location, which is different from an automated driver), to name a few. In terms of communication pathways, the safety processors are architecturally and/or logically disposed between the partitioned application processor and the vehicle subsystems. Due to this arrangement, the requests from the applications are routed through the safety processors for arbitration. In other words, due to the arrangement, the requests from the applications are prevented from being transmitted to the vehicle subsystems without first passing through the safety processors.

The safety processors receive the requests from the applications over the connection with the partitioned application processor. Once the requests are received, the safety processors arbitrate the requests based on defined safety rules for upholding any applicable safety standards, e.g., ASIL-D. To arbitrate the requests, the safety processors permit requests that satisfy the safety rules and actuate subsystems of the vehicle to perform the operations of permitted requests. The safety processors also deny requests that fail to satisfy the safety rules and do not actuate subsystems of the vehicle to perform the operations of denied requests. Instead, in one or more implementations, denied requests are discarded. By routing the requests through the safety processors, the system is able to maintain an operating state of the vehicle within a safe operating envelope while concurrently executing applications which may not uphold applicable safety standards.

Accordingly, developers of applications for a vehicle that includes the described system need not worry about coding their applications to maintain safe operation of the vehicle. As a result, new applications are deployable to the vehicle without having to be coded or independently tested and verified to satisfy stringent safety standards. Application development for the vehicle is thus simplified and made easier, for example, to application developers that are not experts in vehicle safety. Additionally, such applications may be updated without requiring recertification of the vehicle to the desired or required safety standard, which can take years.

In some aspects, the techniques described herein relate to a system including: one or more subsystems of a vehicle, each of the one or more subsystems configured to perform an operation of the vehicle; and a central control unit of the vehicle, the central control unit including: a first processor configured to execute applications associated with the vehicle; and a second processor configured to maintain an operating state of the vehicle within a safe operating envelope of the vehicle, wherein the second processor receives requests from the applications executed by the first processor to perform operations and outputs commands to actuate the one or more subsystems of the vehicle to perform the operations based on the requests satisfying safety rules for the vehicle.

In some aspects, the techniques described herein relate to a system, wherein the second processor prevents requests for operations that fail to satisfy the safety rules from being communicated to the one or more subsystems of the vehicle.

In some aspects, the techniques described herein relate to a system, wherein the second processor provides an application programming interface for the applications which prevents access by the applications to the one or more subsystems unless the requests satisfy the safety rules.

In some aspects, the techniques described herein relate to a system, wherein the first processor is partitioned from the second processor such that the second processor maintains safe operation of the vehicle when execution of the applications by the first processor causes a malfunction with the first processor.

In some aspects, the techniques described herein relate to a system, wherein the central control unit further includes a third processor configured to operate redundantly with the second processor to maintain the operating state of the vehicle within the safe operating envelope of the vehicle.

In some aspects, the techniques described herein relate to a system, wherein: the third processor is configured to maintain the operating state of the vehicle within the safe operating envelope of the vehicle when a malfunction occurs with the second processor; and the second processor is configured to maintain the operating state of the vehicle within the safe operating envelope of the vehicle when a malfunction occurs with the third processor.

In some aspects, the techniques described herein relate to a system, wherein satisfying the safety rules includes satisfying Automotive Safety Integrity Level D (ASIL-D) operation of the vehicle.

In some aspects, the techniques described herein relate to an electronic control unit for controlling operation of a vehicle, the electronic control unit including: a first processor configured to execute applications associated with the vehicle; and a second processor communicably coupled to the first processor, the second processor configured to: actuate subsystems of the vehicle to operate the vehicle based on a safety standard; receive requests for the subsystems to perform operations from the first processor, the requests received in connection with executing the applications; and filter the requests by permitting the requests that satisfy the safety standard and actuating the subsystems to perform the operations of the permitted requests.

In some aspects, the techniques described herein relate to an electronic control unit, wherein the second processor is further configured to filter the requests by denying the requests that fail to satisfy the safety standard.

In some aspects, the techniques described herein relate to an electronic control unit, wherein the second processor does not actuate the subsystems to perform the operations of the denied requests.

In some aspects, the techniques described herein relate to an electronic control unit, wherein the first processor is physically partitioned from the subsystems of the vehicle and the requests for the subsystems to perform the operations from the first processor are routed to the second processor via a communicative coupling.

In some aspects, the techniques described herein relate to an electronic control unit, wherein the second processor is configured to actuate the subsystems of the vehicle to control motion of the vehicle based on the safety standard.

In some aspects, the techniques described herein relate to an electronic control unit, further including a third processor communicably coupled to the first processor, the third processor configured, redundantly with the second processor, to: actuate the subsystems of the vehicle to operate the vehicle based on the safety standard; receive the requests for the subsystems to perform the operations from the first processor; and filter the requests by permitting the requests that satisfy the safety standard and actuating the subsystems to perform the operations of the permitted requests.

In some aspects, the techniques described herein relate to an electronic control unit, wherein the first processor is physically partitioned from the subsystems of the vehicle and the requests for the subsystems to perform the operations from the first processor are routed to only the second processor and the third processor via communicative couplings.

In some aspects, the techniques described herein relate to an electronic control unit, wherein the safety standard is Automotive Safety Integrity Level D (ASIL-D).

In some aspects, the techniques described herein relate to an electronic control unit, wherein the first processor is partitioned from the second processor such that the applications are limited to being executed by the first processor.

In some aspects, the techniques described herein relate to an electronic control unit, wherein the second processor includes one or more I/O ports for at least one of communicative couplings with the subsystems of the vehicle, control signals with the subsystems of the vehicle, or I/O signals with the subsystems of the vehicle.

In some aspects, the techniques described herein relate to an electronic control unit, wherein the first processor includes a memory, the second processor includes a memory, the memory of the first processor is isolated from the memory of the second processor, and the first processor is further configured to execute the applications using only the memory of the first processor.

In some aspects, the techniques described herein relate to an electronic control unit, wherein the applications are prevented from using at least one of the memory of the second processor or peripheral signal I/O of the second processor.

In some aspects, the techniques described herein relate to a method implemented by an electronic control unit for controlling operation of a vehicle, the method including: actuating, by a first processor of an electronic control unit, subsystems of a vehicle to operate the vehicle based on a safety standard; receiving, by the first processor, requests for the subsystems to perform operations, the requests received from a second processor of the electronic control unit in connection with the second processor executing applications associated with the vehicle; and filtering, by the first processor, the requests by permitting the requests that satisfy the safety standard and actuating the subsystems to perform the operations of the permitted requests.

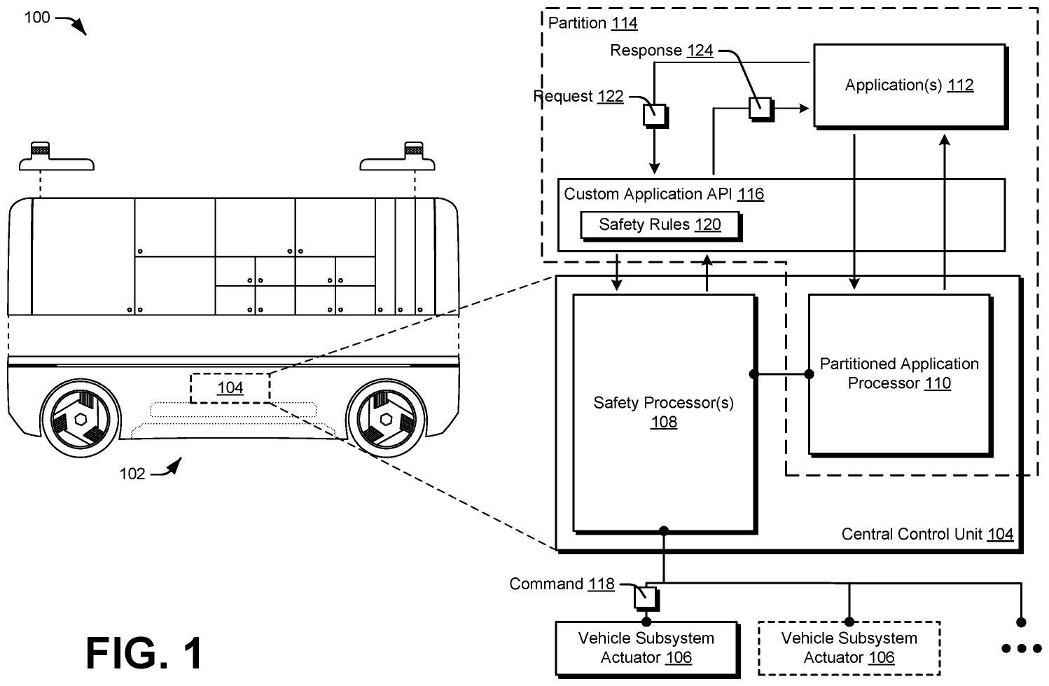

FIG. 1 is a block diagram of a non-limiting example 100 including a vehicle having an architecture to operate the vehicle safely while executing custom applications.

The example 100 includes a vehicle 102, which is configured to operate in any of a variety of vehicle operating environments, examples of which include but are not limited to a roadway, a traffic scenario, an off-road area (e.g., a construction site, a mining operation, a recreational area), in the air, on or in the water, on or in other substances (e.g., within fluids and/or cellular material), in space, and other public or private spaces, to name a few. The vehicle 102 may be any type of vehicle including, for example, ground vehicles (e.g., truck, car, van, tractor-trailer, tank, etc.), air vehicles, rail vehicles, marine vehicles, space vehicles, or other types of vehicles. The vehicle 102 in at least one example is unmanned (e.g., autonomously controlled, remotely controlled), and in at least one other example the vehicle 102 is manned (e.g., semi-autonomously controlled, at least partially human operated).

In the illustrated example 100, the vehicle 102 includes a central control unit 104. The central control unit 104 is connected to a plurality of vehicle subsystem actuators 106 to control respective vehicle subsystems (not shown). Examples of such vehicle subsystems include but are not limited to steering control, brake control, motor control, wing control, rotor control, motion control, traction energy, energy management, power, battery and charging, connectivity (e.g., data and telemetry, cellular, Bluetooth, near-field communication (NFC), 5G, etc.), sensors (e.g., camera(s), proximity, lidar, radar, temperature, etc.), human machine user interfaces of the vehicle 102 (e.g., screens and/or display devices), in-vehicle infotainment, HVAC (heating, ventilation, and air conditioning), lighting (e.g., interior and/or exterior), windshield and/or other wipers, seating, locking (e.g., doors), window actuation, alarms and alerts, payload services, and extensible-assembly control (e.g., pod control, exterior tool control, etc.), to name just a few.

In this example 100, the central control unit 104 includes safety processor(s) 108 and a partitioned application processor 110. In one or more implementations, the partitioned application processor 110 is partitioned from other hardware of the central control unit 104, e.g., from the safety processor(s) 108, in any of a variety of ways. In at least one variation, for instance, the partitioned application processor 110 is separate hardware from the safety processor(s) 108, e.g., a separate processing unit and/or processor card. Alternatively or additionally, the partitioned application processor 110 is “firewalled” from other components of the central control unit 104, e.g., from the safety processor(s) 108. By way of example, at least one of a physical device or software implements a firewall between the partitioned application processor 110 and other components of the central control unit 104.

Further, in at least one implementation, the safety processor(s) 108 and the partitioned application processor 110 each include respective memory. For example, the safety processor(s) 108 includes memory and the partitioned application processor 110 includes memory. As part of partitioning the partitioned application processor 110 from other hardware of the central control unit 104, in one or more implementations, the memory of the partitioned application processor 110 is isolated, such as from the memory of the safety processor(s) 108. In such implementations, the partitioned application processor 110 may be limited to accessing its isolated memory and/or may be prevented from directly accessing the memory of the safety processor(s) 108. It is to be appreciated that the partitioned application processor 110 may be partitioned from the safety processor(s) 108 and other components of the central control unit 104 and/or the vehicle 102 in a variety of ways.

In one or more implementations, the central control unit 104 is an electronic control unit or “ECU,” or the central control unit 104 is included in an electronic control unit. Thus, in at least one implementation, the safety processor(s) 108 and the partitioned application processor 110 are all included as part of, or in, a single electronic control unit. This contrasts with conventional architectures that include a distributed network of multiple electronic control units disposed throughout the vehicle, such as an architecture having individual electronic control units for each vehicle subsystem or having ECUs for many such vehicle subsystems.

Further, in at least one implementation, the central control unit 104 includes two of the safety processor(s) 108. In such implementations, the safety processor(s) 108 may be configured to redundantly operate the vehicle 102. For instance, each of those safety processor(s) 108 may be configured to receive the same inputs from perception devices and/or systems of the vehicle 102, perform vectoring computations in the same manner, output the same motion control commands based on same vectoring computations, and so forth. In this way, in the event a first of the safety processor(s) 108 fails or experiences an issue or malfunction that could impact safety, the second of the safety processor(s) 108 can seamlessly assume control of the vehicle 102.

In accordance with the described techniques, the safety processor(s) 108 controls the motion and vectoring of the vehicle 102. In other words, the safety processor(s) 108 maintains an operating state of the vehicle 102 (e.g., the vehicle's position and location) within a safe operating envelope of the vehicle 102. As used herein, the term “safe operating envelope” refers, for example, to a boundary around the vehicle within which other objects (e.g., other vehicles, property, or people) should not be present, adherence to a safe path within tolerances, and operation within performance parameters, to name just a few. In aviation, an aircraft's performance envelope may be a similar term, and may be used interchangeably with safe operating envelope when the vehicle is aircraft.

By contrast to the safety processor(s) 108, the partitioned application processor 110 is configured to execute one or more application(s) 112, e.g., custom and/or third-party applications. Examples of which include, but are not limited to, applications to control vehicle user interfaces, in-vehicle infotainment, power doors, HVAC, lighting, extensible tools, and so forth. By partitioning the partitioned application processor 110 from the safety processor(s) 108, issues that arise due to executing those application(s) 112, such as software issues, hardware issues (e.g., of the partitioned application processor 110), and/or single event upset failures, are prevented from affecting safe motion and control of the vehicle 102. In other words, the partitioning of the partitioned application processor 110 from the safety processor(s) 108 prevents the application(s) 112 from interfering with safety-critical vehicle operations, like motion control and vectoring.

Even though the partitioned application processor 110 is partitioned from the safety processor(s) 108 in one or more ways, the partitioned application processor 110 is communicably coupled with the safety processor(s) 108. By way of example, the safety processor(s) 108 and the partitioned application processor 110 are communicably coupled via one or more wired or wireless connections. Example wired connections include, but are not limited to, Ethernet connections or links, memory channels, buses (e.g., a data bus, a system or address bus), interconnects, through silicon vias, traces, pins and sockets, and planes, to name just a few. Other example connections include optical connections, fiber optic connections, and/or connections or links based on quantum entanglement.

In accordance with the described techniques, the safety processor(s) 108 and the partitioned application processor 110 communicate, such as over the wired and/or wireless connection, to control one or more subsystems of the vehicle 102 in connection with executing the application(s) 112. Notably, though, the partitioned application processor 110 is configured to execute the application(s) 112 using its respective processor core(s) and memory (not shown). Through implementing partition 114, the application(s) 112 are not executed using any core(s) and/or memory of the safety processor(s) 108. In at least one variation, the application(s) 112 are prevented from using cores and/or memory of the safety processor(s) 108.

In one or more implementations, the partition 114 is implemented at least in part by hardware partitioning as discussed above. Additionally or alternatively, the partition 114 is implemented at least partially by software and/or firmware, such as by using an application programming interface (API). In this example 100, for instance, custom application API 116 is shown, which is provided as a result of the safety processor(s) 108 executing instructions of the custom application API 116 using cores and memory of the safety processor(s) 108.

Accordingly, the partition 114 physically partitions the partitioned application processor 110 from other hardware components (e.g., the safety processor(s) 108 and the plurality of vehicle subsystem actuators 106) of the central control unit 104, and the partition 114 also functionally partitions the application(s) 112 from directly accessing or otherwise using those other components, such that the application(s) 112 are prevented from accessing any vehicle subsystems without going through the custom application API 116 and/or some other interface of the safety processor(s) 108.

In operation, an application(s) 112 requests that a vehicle subsystem perform some action during execution of the application(s) 112, e.g., to open or close a door, cause display of a user interface, turn lights on or off, travel to a destination according to navigation directions, etc. The safety processor(s) 108 arbitrates those requests, e.g., it permits a request or denies the request. If the safety processor(s) 108 permits such a request, then the safety processor(s) 108 controls the respective vehicle subsystem to carry out the requested action. For example, the safety processor(s) 108 sends a command 118 to one or more of the vehicle subsystem actuators 106 to cause the respective vehicle subsystems to perform the requested action. If the safety processor(s) 108 denies such a request, however, the safety processor(s) 108 does not carry out the requested action, e.g., the door is not opened or closed, the user interface is not displayed, the lights are not turned on or off, etc. When the request is denied, the safety processor(s) 108 does not send a command 118 to any of the vehicle subsystem actuators 106 to perform the requested action. In at least one variation, the safety processor(s) 108 discards denied requests. In one or more implementations, the processor(s) 108 executes instructions of the custom application API 116 to permit or deny requests based on safety rules 120.

In the context of the illustrated example 100, consider the following discussion. The partitioned application processor 110 executes application(s) 112 within the partition 114, such as by using one or more cores and memory of the partitioned application processor 110 to execute instructions of those applications. Examples of such applications (e.g., custom and third-party applications) are discussed above and below. Broadly, the application(s) 112 are intended to affect some aspect of the vehicle 102 during execution, such as to control interior climate, actuate a component (e.g., door or hatch), or display user interfaces, to name just a few. To do so, an application(s) 112 outputs a request 122 to the custom application API 116. The request 122 indicates at least one operation for at least one subsystem of the vehicle 102 to perform. For example, the request 122 indicates the operation of opening a door which is to be performed by a power door subsystem of the vehicle 102. From a hardware perspective, the partitioned application processor 110 transmits the request 122 to the safety processor(s) 108, e.g., via the above discussed one or more wired or wireless connections.

The safety processor(s) 108 receives the request 122 over the connection and executes the custom application API 116 to arbitrate the request 122. The custom application API 116 receives the request 122 as input and determines whether to permit the request or deny the request 122. In one or more implementations, the custom application API 116 arbitrates the request 122 based at least in part on the safety rules 120. For example, if the custom application API 116 determines that the request 122 satisfies the safety rules 120, then the custom application API 116 permits the operation specified in the request 122. In connection with permitting the request 122, the safety processor(s) 108 outputs at least one command 118 that is transmitted over a vehicle network to actuate at least one vehicle subsystem actuator 106 to perform the requested operation. However, if the custom application API 116 determines that the request 122 does not satisfy the safety rules 120, then the custom application API 116 denies the operation specified in the request 122. In connection with denying the request 122, the safety processor(s) 108 does not output a command 118 to actuate at least one vehicle subsystem actuator 106 to perform the requested operation. Further, in at least one variation, the safety processor(s) 108 discards a denied request.

In one or more implementations, the custom application API 116 outputs a response 124 to the application(s) 112 that sent the request 122. By way of example, the response 124 may indicate the custom application API 116's determination made as a result of arbitrating of the request, such as whether the request 122 was permitted or denied. Additionally or alternatively, the response 124 may include other information, examples of which include one or more reasons why a request was permitted or denied, system messages associated with the request (subsystem status or state messages), and so forth.

In one or more implementations, the safety rules 120 correspond to at least one safety standard for operating vehicles, examples of which include Automotive Safety Integrity Level D (ASIL D), ASIL C, ASIL B, and ASIL A. The international organization of standardization (ISO) publishes ISO standard 26262, which is titled “Road vehicles—Functional Safety.” This standard defines a set of functional safety requirements of different electrical and electronics systems in a vehicle. In some jurisdictions, adherence to this standard is a condition for allowing a vehicle to operate on a road. The standard assigns an Automotive Safety Integrity Level (ASIL) to each part or function of a vehicle. As noted above, there are four different ASILs including ASIL-A, which is assigned to vehicle functions and parts that present a lowest risk to safety and ASIL-D, which is assigned to vehicle functions and parts that present a highest safety risk. For example, ASIL-D is used for vehicle components involved in high exposure driving situations where malfunctions cause vehicles to be most difficult to control, which can lead to death or major bodily harm.

Other examples of safety standards, which may additionally or alternatively correspond to or otherwise be maintained by adhering to the safety rules 120, include but are not limited to, Safety Integrity Level 4+ (SIL-4+), SIL-4, SIL-3, SIL-2, SIL-1 (general safety as standardized in the International Electrotechnical Commission's IEC 61508 or railway safety as standardized in the Comité Européen de Normalisation Électrotechnique CENELEC 50126); Category A, Category B, Category C, Category D, Category E (space safety as standardized in the European Cooperation for Space Standardization ECSS-Q-ST-80); Design Assurance Level A (DAL-A), DAL-B, DAL-C, DAL-D, and DAL-E (airborne aviation safety as standardized in EUROCAE's ED-12C and RTCA's DO-178C and DO-254); to name just a few. Additional example safety rules include but are not limited to, AL6, AL5, AL4, AL3, AL2, AL1 (ground based aviation system security as standardized in EUROCAE's ED-109 and RTCA's DO-278); Class A, Class B, Class C (medical and household safety as standardized in IEC 62304 and IEC 60730); and PL a, PL b, PL c, PL d, and PL e (machinery safety as standardized in ISO 13849), and so on. In this way, if operation of the vehicle 102 satisfies the safety rules 120, then the vehicle 102's operation satisfies (or is in compliance with) the standard to which the safety rules 120 correspond. Consider an example in which the safety rules 120 correspond to ASIL-D. In this example, if operation of the vehicle 102 satisfies the safety rules 120, then the vehicle 102's operation therefore satisfies ASIL-D.

Accordingly, by arbitrating requests 122 from the application(s) 112 based on safety rules 120 that are ASIL-D compliant, the custom application API 116 ensures that operation of the vehicle 102 satisfies ASIL-D, even when executing third-party or custom applications which may not themselves satisfy ASIL-D requirements. In one or more implementations, the safety processor(s) 108 are ASIL-D compliant, such that the architecture of the safety processor(s) 108 and/or the operations they perform are configured to satisfy ASIL-D. For example, the safety processor(s) 108 are configured to control motion and vectoring of the vehicle 102 in a manner that satisfies ASIL-D. Since any requests from the application(s) 112 are architecturally routed through the safety processor(s) 108 and because the safety processor(s) 108 perform (e.g., only) operations which satisfy ASIL-D, the safety processor(s) 108 do not permit requested operations which fail to satisfy ASIL-D. Although ASIL-D is discussed in the immediately preceding example, it is to be appreciated that any vehicle safety standard or combination of them may be used in accordance with the described techniques.

Since the partition 114 and the safety processor(s) 108 deny any requests from the application(s) 112 that would compromise the safety of the vehicle 102, passengers and/or cargo of the vehicle 102, other vehicles near the vehicle 102, other physical property near the vehicle 102, and so on, the safety processor(s) 108 offload the responsibility of vehicle safety from the application(s) 112. In other words, because the safety processor(s) 108 ensure the vehicle 102's safe operation, developers of the application(s) 112 need not worry about coding their application(s) 112 to maintain safe operation of the vehicle 102. Rather than rely on the application(s) 112 to maintain compliance with ASIL-D, the safety processor(s) 108 arbitrate whether an application request is safe for current operating conditions of the vehicle. In this way, new applications are deployable to the vehicle 102 without having to be coded or independently tested and verified to satisfy stringent safety standards. Application development for the vehicle 102 is thus simplified and made easier, for example, to application developers that are not experts in vehicle safety. The safety processor(s) 108 are configured to maintain safe operation of the vehicle 102 regardless of the operations requested by the application(s) 112 and/or whether execution of the application(s) 112 cause hardware of the partitioned application processor 110 to crash or throw a fault.

Further advantages of this architecture include, but are not limited to, the extensive programmability of the vehicle 102's user experience (e.g., within the vehicle and with applications on other devices such as mobile phones and/or tablets of a wide range of vehicle settings and/or functions) by a wide variety of users (in addition to the vehicle manufacturer), while maintaining one or more safety standards of certified integrity of the control system and vehicle 102. Examples of such extensive and flexible programmability include but are not limited to, programming aspects of cabin user interface(s) and/or user experience, driver interface(s) and/or user experience, autonomous (non-driving) services, human machine interfaces, platform services, and vehicle pod and payload control and management, to name a few. Additionally, the application(s) 112 may be updated (e.g., as updates are made available via the cloud or other connection) without requiring recertification of the vehicle 102 to the desired or required safety standard, which can take years.

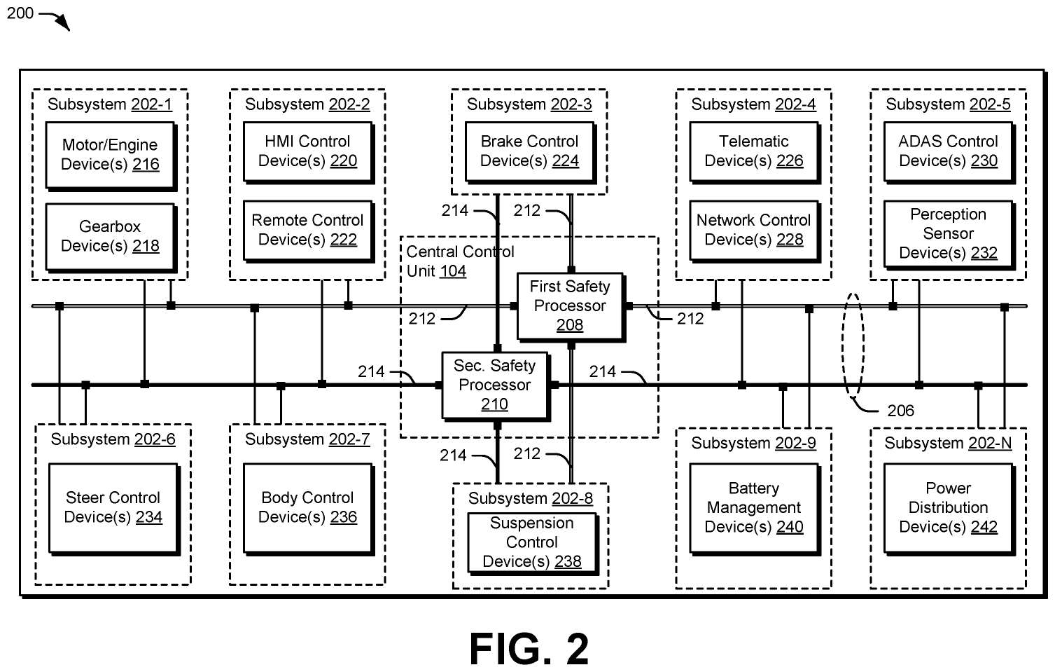

FIG. 2 is a block diagram of a non-limiting example of a vehicle system 200 that implements custom application systems for safe vehicle operation. For ease of description, the vehicle system 200 is described in the context of the example 100 shown in FIG. 1 including with reference to similar labeled elements. For example, the vehicle system 200 includes a central control unit 104. The vehicle system 200 also includes a plurality of subsystems 202 (labeled individually as subsystem 202-1 through subsystem 202-N, where N is any integer) that are managed by the central control unit 104 to implement various vehicle functions. In at least one example, the vehicle system 200 includes additional, fewer, and/or different subsystems 202 than those depicted in FIG. 2.

The central control unit 104 is configured as a centralized controller that enables information to transfer between the subsystems 202 over a vehicle network 206. By exchanging information with the subsystems 202, the centralized controller causes the execution of subsystem functions that enable driving. For instance, the central control unit 104 receives signals output on the network 206 from one of the subsystems 202, and based on information inferred from the signals, the central control unit 104 outputs additional signals on the network 206 to cause a particular behavior of another of the subsystems 202.

In accordance with the described techniques, the central control unit 104 includes a first safety processor 208 and a second safety processor 210. The first safety processor 208 and the second safety processor 210 represent separate processors, processor cards, processor cores, control units, microcontrollers, system on chips, or other processor technology. Each of the first safety processor 208 and the second safety processor 210 are configured to execute instructions either as software or firmware to implement functionality of the central control unit 104. Although not shown, in some examples, the central control unit 104 includes a non-transitory computer-readable storage medium (e.g., data store, cache, static memory, dynamic memory, flash memory, disk storage) that maintains the instructions and data for implementing the instructions executed by each of the first safety processor 208 and the second safety processor 210. For example, the first safety processor 208 and the second safety processor 210 include respective data stores that contain the instructions retrieved from the data stores and executed during operation of the vehicle 102.

In at least one variation, the central control unit 104 is distributed throughout the vehicle system 200 in two or more locations. In such a distributed implementation, the first safety processor 208 is included in a first control system and the second safety processor 210 is included in a second control system. In other distributed implementations, each control system includes one or more safety processors.

In one or more examples, the first safety processor 208 and the second safety processor 210 are functionally redundant. The vehicle system 200 relies on either the first safety processor 208 or the second safety processor 210 (e.g., one at a time) to actively cause operations to be performed by the subsystems 202. For example, while the first safety processor 208 is orchestrating operations of the subsystems 202, the second safety processor 210 is maintained in a ready, standby state. Notably, in this ready standby state, the second safety processor 210 also runs as if it is operating the vehicle, e.g., making vehicle control and vectoring decisions as if it is responsible for operating the vehicle in real-time.

If the first safety processor 208 fails, then the central control unit 104 activates the second safety processor 210 to seamlessly take over and manage the subsystems 202 where the first safety processor 208 left off. When the second safety processor 210 takes over, the vehicle 102 may be forced to operate in a safe state, which can include autonomously maneuvering away from other vehicles, objects, and pedestrians to come to a controlled stop. This way, the functional redundancy implemented by the first safety processor 208 and the second safety processor 210 help the central control unit 104 to satisfy ASIL-D requirements for reliability and safety. In such implementations, the first safety processor 208 and the second safety processor 210 may be located at different locations within the vehicle.

The vehicle network 206 represents any suitable vehicle network technology, including wired and wireless signal propagation mediums. The vehicle network 206 enables real-time data exchange, safety enhancements, and efficient traffic management among the components of the vehicle system 200. The vehicle network 206 can include various switches, routers, transceivers, controllers, chokes, filters, terminations, and other networking equipment beyond transmission lines, cables, wires, busses, and other signal routing technologies. In at least one implementation, the vehicle network 206 adheres to an in-vehicle networking protocol. For example, the vehicle network 206 represents a combination of one or more of a controller area network (CAN), an automotive ethernet network (AEN), serializer/deserializer (SerDes) network, local interconnect network (LIN), or a FlexRay network (FRN), to name a few.

In at least one example, to implement the redundancy of the central control unit 104, the vehicle network 206 is composed of dual physical network paths. A network path 212 communicatively couples each of the subsystems 202 to the first safety processor 208. A separate network path 214 communicatively links each of the subsystems 202 to the second safety processor 210. For example, if a failure at the first safety processor 208 is at least partially caused by a fault in the network path 212, the second safety processor 210 is unaffected by the network fault and operable to communicate with the subsystems 202 using the network path 214. The functional redundancy implemented by the network paths 212 and 214 further helps the central control unit 104 to satisfy the ASIL-D requirements for reliability and safety.

In at least one other example, to implement the redundancy of the central control unit 104, the vehicle network 206 is composed of dual logical network paths. The network path 212 and the network path 214 may be separate logical paths through the vehicle network 206 that communicatively link each of the subsystems 202 to the first safety processor 208 and the second safety processor 210 using the same physical wires. For example, communications to and from the first safety processor 208 and the second safety processor 210 are interleaved on a single set of wires that make up the vehicle network 206. If a failure at the second safety processor 210 and/or the network path 214 occurs, communications from the first safety processor 208 can reach the subsystems 202 using the network path 212. The functional redundancy implemented by interleaving the network paths 212 and 214 further helps the central control unit 104 to satisfy the ASIL-D requirements for reliability and safety.

The subsystems 202 include one or more edge devices operatively coupled to the vehicle network 206 to provide information to the central control unit 104 and receive commands from the central control unit 104 to implement various vehicle functions. For example, each of the subsystems 202 can include one or more actuators, microcontrollers, machines, or other equipment to perform specific vehicle tasks at the discretion of the edge devices that are contained within the subsystems 202.

In one or more implementations, the vehicle includes a subsystem 202-1 which is a propulsion or drive subsystem. Motor/engine devices 216 of the subsystem 202-1 represent edge devices managed by the central control unit 104 to command vehicle propulsion units (e.g., an engine, a motor) to execute driving functions of the vehicle 102 (e.g., forward motion, reverse motion, acceleration, deceleration). In one or more examples, the motor/engine devices 216 manage operations of an engine of the vehicle 102, including fuel injection, ignition timing, emissions control, and engine health monitoring. In at least one aspect (e.g., in context of electric vehicles), the motor/engine devices 216 control inverters and motors that convert electric energy into mechanical energy for applying torque to wheels.

In addition, the subsystem 202-1 includes gearbox devices 218. Also referred to as a powertrain control module (PCM) and/or a transmission control module (TCM), transmission and gearbox functions are overseen by the gearbox devices 218 to implement an automatic transmission, optimize gear changes (e.g., gear shifts), and control torque delivered to the wheels of the vehicle 102. In variations, a vehicle may include one or more subsystems 202-1, e.g., one subsystem 202-1 for each axle.

A subsystem 202-2 is a human machine interface (HMI) subsystem. The subsystem 202-2 includes one or more HMI control devices 220 that implement a vehicle user interface. The vehicle user interface enables interaction between occupants (e.g., driver, passenger) of the vehicle 102 and the vehicle system 200, which enables human intervention in vehicle functions and driving. For example, the HMI control devices 220 control vehicle displays, vehicle dash clusters, heads-up display units, haptic feedback, audible feedback, and other visual driving aids interpreted by the occupants to help with driving or ensuring safe vehicle operations. In one or more implementations, the HMI control devices 220 provide a human-interface to effect climate controls (e.g., heating, cooling), cabin features (e.g., infotainment, lighting), and other vehicle body features (e.g., windshield wipers, transmission settings, suspension settings, drive mode selection, power seating, power mirrors, power door locks, etc.).

The subsystem 202-2 also includes one or more remote control devices 222 that allow human or machine inputs to control the vehicle 102 from outside the cabin. For example, in an autonomous or semi-autonomous vehicle context, the remote control devices 222 receive commands over a communication link with a base station (e.g., a mobile phone, a key fob, a remote computing system) to allow a human or machine operator to control the vehicle 102 as if the driving commands are provided directly to the HMI control devices 220. In hot or cold weather, to pre-cool or pre-heat the cabin, the remote control devices 222 may activate remote starting functions. The remote control devices 222 in at least one aspect allow door locks to be locked or unlocked and doors, tailgates or trunks to be remotely opened or closed.

A subsystem 202-3 represents a braking subsystem of the vehicle system 200. For example, one or more brake control devices 224 are operable to manage anti-lock braking systems (ABS), electronic stability controls (ESC), and otherwise convert driver inputs at the HMI control devices 220 to effect performance of vehicle brakes (e.g., for stopping, for decelerating, etc.). In some examples, the brake control devices 224 represent a braking control module (BCM).

Another of the subsystems 202 depicted in FIG. 2 is subsystem 202-4, which is an onboard-vehicle communication subsystem. The subsystem 202-4 manages telematics and communications that occur within the vehicle 102, and with other devices located outside the vehicle 102. For example, the subsystem 202-4 interfaces with the various edge devices coupled to the vehicle network 206 to ensure healthy exchange of data that is free of errors or faults. In addition, the subsystem 202-4 interfaces with other vehicles, mobile devices, infrastructure, and remote computing systems to implement various vehicle functions. One or more network control devices 228 of the subsystem 202-4 monitor network health of the vehicle network 206 and facilitate communication protocols implemented therein. The network control devices 228 are configured to diagnose problems with the vehicle network 206 to reroute signals and prevent data loss.

One or more telematic devices 226 of the subsystem 202-4 handle offboard communications of the vehicle 102. This includes implementing vehicle-to-vehicle (V2V) and vehicle-to-everything (V2X) communications that enable the vehicle 102 to communicate with other intelligent vehicles and systems in an operating environment, e.g., on or near a roadway. The telematic devices 226 interface with over-the-air (OTA) update services to update software on the vehicle 102, such as the application(s) 112 and/or firmware or software executed by the first safety processor 208 and/or the second safety processor 210, e.g., the custom application API 116 and/or a vehicle operating system. In addition, the telematic devices 226 interface with a positioning system to assist with navigation functions. Other features implemented by the telematic devices 226 include remote diagnostics and interfacing with emergency response services, e.g., to automatically alert emergency responders in the event of an accident.

Subsystem 202-5 is an advanced driving and safety (ADAS) subsystem of the vehicle system 200. In at least one implementation, the subsystem 202-5 has two main functions, including implementing an ADAS as well as a perception sensor system. For example, one or more ADAS control devices 230 implement ADAS functionality that includes autonomous or semi-autonomous control, adaptive cruise control, emergency braking, lane centering, and other ADAS functions. One or more perception sensor devices 232 support the ADAS control devices 230 by providing information about the driving environment to ensure safe driving. For example, a radar, a camera, a lidar, an ultrasonic sensor, a global position system (GPS) sensor, an inertial measurement unit (IMU), and other sensor technology is deployed by the perception sensor devices 232 to collect sensor data about a vehicle environment. Sensor fusion techniques, object detection, lane centering, path trajectory planning, and other perception sensor functions are executed by the perception sensor devices 232 to enable the ADAS functions performed by the ADAS control devices 230.

Subsystem 202-6 is a steering subsystem that controls components of the vehicle which steer the wheels. One or more steer control devices 234 integrate with an electric power steering system of the vehicle 102 to control direction of the vehicle wheels. The steer control devices 234 may receive inputs from the HMI control devices 220 and/or the central control unit 104, which are translated into appropriate steering commands for controlling steering actuators that change the direction of the wheels for steering and performing evasive maneuvers.

Subsystem 202-7 represents a body control subsystem of the vehicle 102. Included in the subsystem 202-7 are one or more body control devices 236, which handle functions related to vehicle body controls. For example, window actuators, door locks and latches, interior and exterior lighting, tailgate and trunk latches, and the like are controlled by the body control devices 236 at the command of the central control unit 104 and/or one or more of the other subsystems 202 (e.g., the HMI control devices 220).

Subsystem 202-8 is an active suspension control subsystem. One or more suspension control devices 238 implement functions of a suspension control module (SCM) to regulate suspension components to adjust a ride level of the vehicle 102. For example, the suspension control devices 238 configure a vehicle suspension to be stiffer on paved surfaces for improved driving performance and maneuverability. In an offroad setting, though, the suspension control devices 238 may enable a softer suspension setting to provide a smoother ride.

Subsystem 202-9 represents a battery management subsystem of the vehicle 102. One or more battery management devices 240 monitor performance of a battery pack (also referred to as a traction battery) to ensure appropriate charging and discharging rates to promote longevity and overall battery health. The battery management devices 240 control charging operations of onboard vehicle batteries as well as controlling battery usage, e.g., to control a rate of discharge. The battery management devices 240 monitor health of vehicle batteries to alert the central control unit 104 when a malfunction is imminent or occurring.

Finally, subsystem 202-N is depicted in FIG. 2, which represents a power distribution system. In variations, one or more power distribution devices 242 of the subsystem 202-N manage the distribution of electrical power from energy sources on the vehicle 102 to the vehicle system 200. For example, the power distribution devices 242 control power switches, inverters, converters, and other electrical distribution components to ensure the subsystems 202 receive an appropriate level of current and voltage for implementing vehicle functions. The power distribution devices 242 can include fault protection circuits and breakers to interrupt power to a faulty subsystem and maintain safe electrical conditions while the vehicle 102 remains active. The power distribution devices 242 interface with the motor engine devices 216 and the battery management devices 240 to manage safe electrical conditions throughout the vehicle system 200.

The various subsystems 202 may be controlled by the first safety processor 208 and/or second safety processor 210 (examples of the safety processor(s) 108) in connection with a variety of use cases implemented by custom applications executed by the partitioned application processor 110. In this context, consider the following examples.

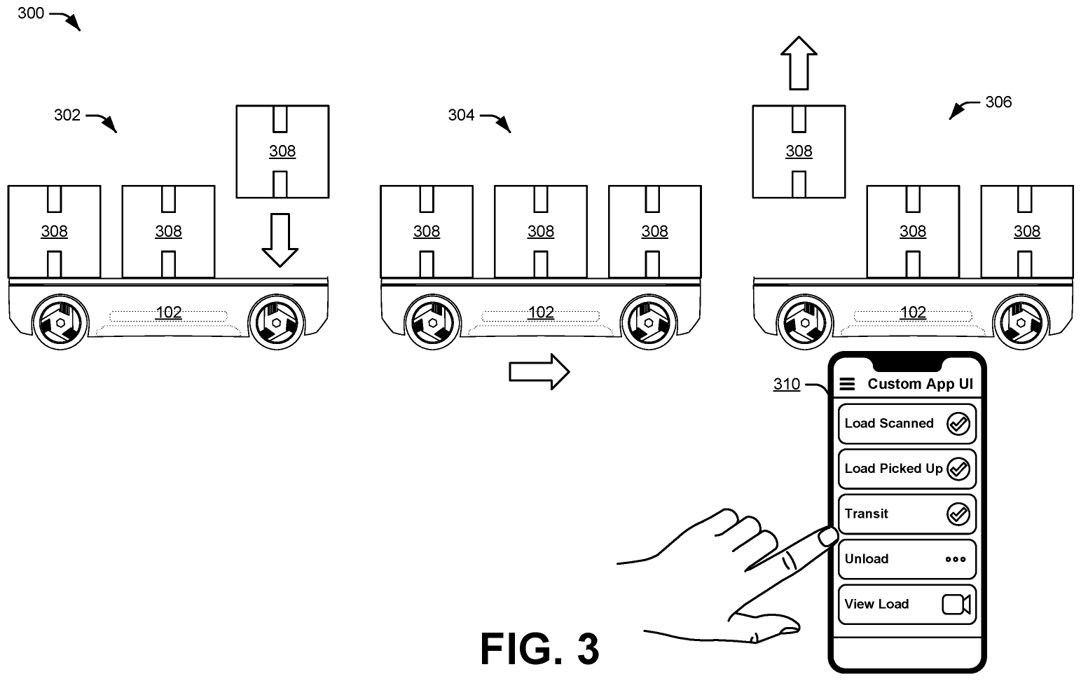

FIG. 3 depicts an example 300 implementation of custom application systems for safe vehicle operation.

In particular, the example 300 depicts the vehicle 102 at three different stages of one example use case, i.e., a first stage 302, second stage 304, and third stage 306. For instance, the example 300 depicts three different stages of a use case in which one or more items 308 are autonomously delivered by the vehicle 102 to one or more locations of a job site, such as a manufacturing or other industrial plant, a construction site, a mine, a farm, or a ranch, to name a few.

During the three different stages, the partitioned application processor 110 executes application(s) 112 within the partition 114, and the application(s) 112 causes requests 122 to be sent to the safety processor(s) 108 via the custom application API 116 to control one or more operations of the vehicle 102. By way of example, the requests output by the application(s) 112 correspond to various operations of the vehicle 102 that are associated with delivering the one or more items 308 to various locations of a job site. As discussed above, the safety processor(s) 108 executes the custom application API 116 to arbitrate those requests based on the safety rules 120, e.g., by permitting and denying the requests based on the safety rules thereby ensuring that operation of the vehicle satisfies a safety standard such as ASIL-D.

The first stage 302 represents operation of the vehicle 102 associated with loading one or more items 308 on the vehicle 102, e.g., picking up the one or more items 308 at an origin location of the delivery. In at least one variation, the vehicle 102 includes one or more systems for detecting and/or monitoring a load, such as in connection with pick up of the one or more items 308. Examples of such systems include sensor systems, e.g., weight sensors, imaging sensors, proximity sensors, capacitive sensors, temperature sensors, and so on. In accordance with the described techniques, the vehicle 102 can provide data produced about the load by those one or more systems to the application(s) 112 via the safety processor(s) 108 and the custom application API 116.

The application(s) 112 can then cause such information to be processed for any of a variety of purposes, such as to cause information about the load to be communicated to and displayed at an external computing device 310. In one or more implementations, for example, the partitioned application processor 110 is coupled to an interface which connects the partitioned application processor 110 to one or more networks, examples of which include cellular networks, Wi-Fi networks, short range communication networks (e.g. Bluetooth), satellite networks, and so on. In at least one variation, the interface which connects the partitioned application processor 110 to one or more such networks is separate from one or more interfaces which connect the safety processor(s) 108 to any of one or more such networks. In other words, the partitioned application processor 110 and the safety processor(s) 108 have separate interfaces which connect them individually to external networks from the vehicle 102.

Alternatively or additionally, the vehicle 102 is assembled with one or more extensible components, e.g., robotic arms, conveyor belts, and so on, which may be actuated responsive to requests from the application(s) 112 (and arbitration by the safety processor(s) 108) to assist with loading the one or more items 308.

The second stage 304 represents operation of the vehicle 102 associated with transporting the one or more items 308 loaded on the vehicle 102 from an origin of the load to a destination of the load, e.g., another location of the job site. In accordance with the described techniques, the application(s) 112 may cause various systems of the vehicle 102 to be employed during transit to monitor and/or report on condition(s) of the one or more items 308 and/or a status of the vehicle, e.g., currently location, remaining time until drop off, estimated time of arrival, etc. In one or more implementations, the application(s) 112 may cause at least a portion of this information to be communicated to and displayed at an external computing device 310. The application(s) 112 may also provide navigation instructions to route the vehicle 102 from the origin location of the load to a destination location of the load.

The third stage 306 represents operation of the vehicle 102 associated with unloading the one or more items 308 from the vehicle 102, e.g., to drop off the one or more items 308 at a destination location of the delivery. In one example, for instance, the vehicle 102 is assembled with one or more extensible components, e.g., robotic arms, conveyor belts, and so on, which may be actuated responsive to requests from the application(s) 112 to assist with unloading the one or more items 308 from the vehicle. Alternatively or additionally, the application(s) 112 may request actuation of one or more systems of the vehicle, e.g., cameras, biometric scanners, and so forth, to verify an identity of a person receiving and/or unloading the one or more items 308 at the destination location. Alternatively or additionally, the application(s) 112 may cause various systems of the vehicle 102 to be employed to monitor and/or report on condition(s) of the one or more items 308 and or a status of the vehicle 102 at a time and location of the drop off. Like with the other stages, the application(s) 112 may cause information associated with any of the operations performed by vehicle 102 to be communicated to and displayed at an external computing device 310.

Regarding the external computing device 310, in one or more implementations, the application(s) 112 executed by the partitioned application processor 110 on the vehicle 102 are associated with one or more companion applications, which are executed on computing devices that are separate from the vehicle 102, such as mobile phones, laptops, tablets, desktops, virtual and/or augmented reality headsets, and so forth. The application(s) 112 of the vehicle 102 and such companion applications may exchange information, such as over a network, which allows the application(s) 112 to receive information (and requests) from the companion applications and the companion applications to receive information (and requests) from the application(s) 112. In this way, the application(s) 112 may receive information about inputs provided via user interfaces of the external computing device 310 and request that the vehicle 102 perform one or more operations in response to those inputs. Further, the application(s) 112 may cause information to be communicated to the external computing device 310 and output (e.g., displayed or audibly output) via the external computing device 310, such as information related to any of a variety of aspects of a use case of the vehicle 102.

As depicted in the example 300, for instance, a user interface of an external computing device 310 can display status information associated with a use case. In the context of autonomous delivery of a load, a user interface can display information about a status of the load (e.g., the completion or progress of different delivery stages) via one or more interactive elements. In this example, the user interface displayed via the external computing device 310 also includes an interactive element which is selectable responsive to user input to actuate one or more subsystems of the vehicle 102, e.g., one or more cameras of the vehicle 102. In accordance with the described techniques, the custom application API 116 may determine whether a request from the application(s) 112 to actuate one or more subsystems (e.g., to actuate one or more cameras) satisfies the safety rules 120 and permit the requested actuation only if it satisfies the safety rules 120. Otherwise, the custom application API 116 denies the requested actuation. It is to be appreciated that the application(s) 112 may provide a variety of information to external computing devices 310 for display or other output, such as information associated with operations of the vehicle 102 that are performed responsive to requests from the application(s) 112.

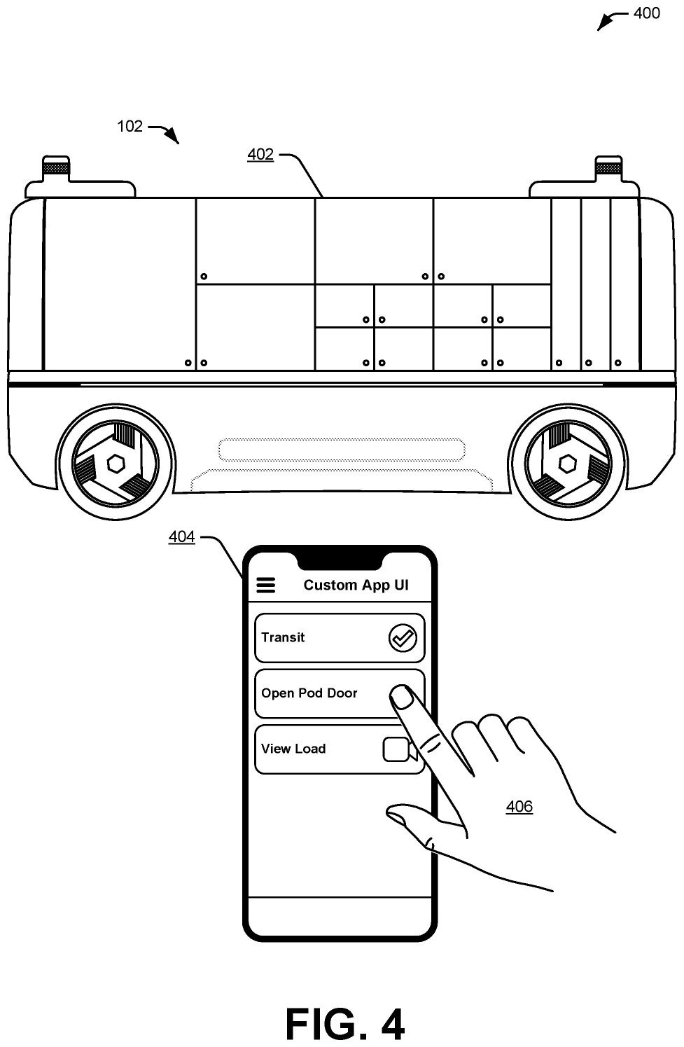

FIG. 4 depicts another example 400 implementation of custom application systems for safe vehicle operation.

In particular, the illustrated example 400 includes the vehicle 102 having a pod 402. In this example 400, the pod 402 is disposed on top of the vehicle, e.g., relative to a surface on which the vehicle travels. In one or more implementations, the pod 402 may be integral with the vehicle 102 in any of a variety of other ways, such as disposed on a side of the vehicle, beneath a body of the vehicle, and so on.

The illustrated example 400 also includes external computing device 404, which is operable by a user 406 that is also external to the vehicle 102. This example 400 represents a scenario where the user 406 may provide input via a user interface displayed via the external computing device 310. In this scenario, the user 406 may provide an input to the user interface for controlling some operation of the vehicle 102 and/or the pod 402. For instance, the user may provide input via the user interface for opening a door of the pod 402. In accordance with the described techniques, the external computing device 404 may communicate an indication of this input to the partitioned application processor 110 over a network (not shown). Responsive to the receipt of the indication, the application(s) 112 corresponding to the companion application of the external computing device 404 may cause a request to be sent from the partitioned application processor 110 to the safety processor(s) 108.

In accordance with the described techniques, the custom application API 116 then arbitrates the received request. Here, the custom application API 116 determines whether opening the pod 402's door satisfies the safety rules 120. If opening the pod 402's door satisfies the safety rules 120, the operation is permitted and the safety processor(s) 108 issues a command to the door subsystem to open the requested door. If opening the pod 402's door does not the safety rules 120, however, the operation is denied and the safety processor(s) 108 discards the request. Further, the safety processor(s) 108 does not issue a command to the door subsystem to open the requested door when a request to do so is denied.

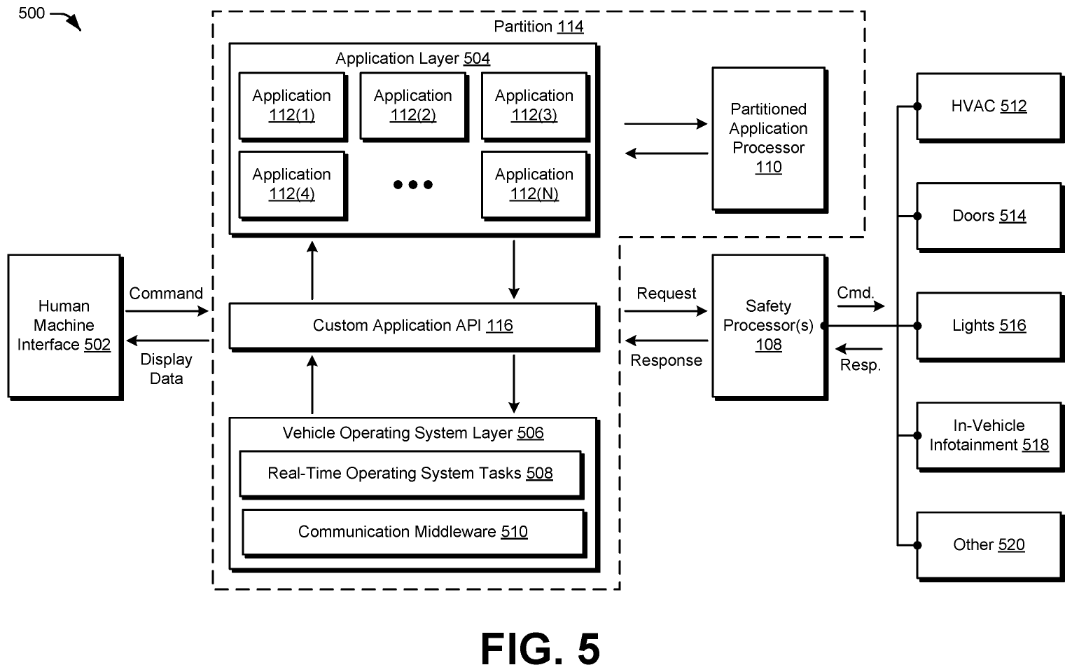

FIG. 5 depicts an example 500 implementation in which an application executed by a custom application system for safe vehicle operation utilizes a human machine interface of a vehicle.

The illustrated example 500 includes the safety processor(s) 108, the partitioned application processor 110, the partition 114, and the custom application API 116. The illustrated example 500 also includes human machine interface 502, an application layer 504, a vehicle operating system layer 506 having real-time operating system tasks 508 and communication middleware 510, and example subsystems of the vehicle 102, including HVAC 512, doors 514, lights 516, in-vehicle infotainment 518, and other 520. It is to be appreciated that different configurations of the vehicle 102 may have different subsystems. For instance, a fully autonomous vehicle that is not configured to transport passengers may not include the in-vehicle infotainment 518 subsystem.

One example of the human machine interface 502 is a touch screen of the vehicle 102, such as a touch screen within a passenger cabin of the vehicle 102. In at least one scenario, input is received via the human machine interface 502, e.g., a touch input in relation to a displayed interactive element. Responsive to such input, the human machine interface 502 communicates a command to the partition 114. For instance the command is provided from the vehicle subsystem (e.g., the human machine interface 502) to the custom application API 116 and forwarded on to the application(s) 112 that relates to the human machine interface 502 or to the application(s) 112 associated with the input.

In accordance with the described techniques, the command from the human machine interface 502 is not simply forwarded to the targeted subsystem to cause the targeted subsystem to perform the commanded operation. Instead, the command is filtered to ensure that performing the operation commanded by the human machine interface 502 is safe given a state of the vehicle 102. To ensure the operation's safety, the application(s) 112 to which the command corresponds submits a request via the custom application API 116 for arbitration. In one or more implementations, the partitioned application processor 110 is not directly connected to one or more subsystems (or any subsystems) of the vehicle 102. The partitioned application processor 110 does not have a direct physical connection between an I/O port of the partitioned application processor 110 and those subsystems. Instead, the safety processor(s) 108 is directly connected (e.g., via wired connections) to the subsystems of the vehicle 102, e.g., there are direct physical connections between I/O ports of the safety processor(s) 108 and the subsystems of the vehicle 102. Due to this architecture, in order to actuate a subsystem, any request or command from the application(s) 112 for a subsystem to perform an operation is channeled through the safety processor(s) 108.

Since the application(s) 112 are being executed by the partitioned application processor 110 and the custom application API 116 is provided by the safety processor(s) 108, this involves transmitting a request over a communicative coupling (e.g., Ethernet) between the partitioned application processor 110 and the safety processor(s) 108. The custom application API 116 determines whether a requested operation satisfies the safety rules 120 as described above and below. If the requested operation is determined to satisfy the safety rules 120, the safety processor(s) 108 submits a command to the respective subsystem to perform the operation, e.g., to the HVAC 512, the doors 514, the lights 516, the in-vehicle infotainment 518, and/or the other 520 subsystem. If the requested operation is determined not to satisfy the safety rules 120, the request is denied and the safety processor(s) 108 discards the request.

In one or more implementations, the vehicle operating system layer 506 is or includes an operating system, configured to manage hardware resources of the vehicle 102, such as memory and cores of the safety processor(s) 108 as well as the subsystems, and is configured to execute real-time operating system tasks 508 within precise timing constraints, e.g., constraints for operating the vehicle 102 safely within an operating envelope. Broadly, real-time operating systems are designed for systems requiring a high degree of predictability and reliability, where the correctness of operation depends not only on the logical correctness of the software but also on the time at which the results are produced. In one or more implementations, the communication middleware 510 is a layer of software that provides a set of services and capabilities for enabling communication and data exchange between different software applications, components, or systems of the vehicle 102.

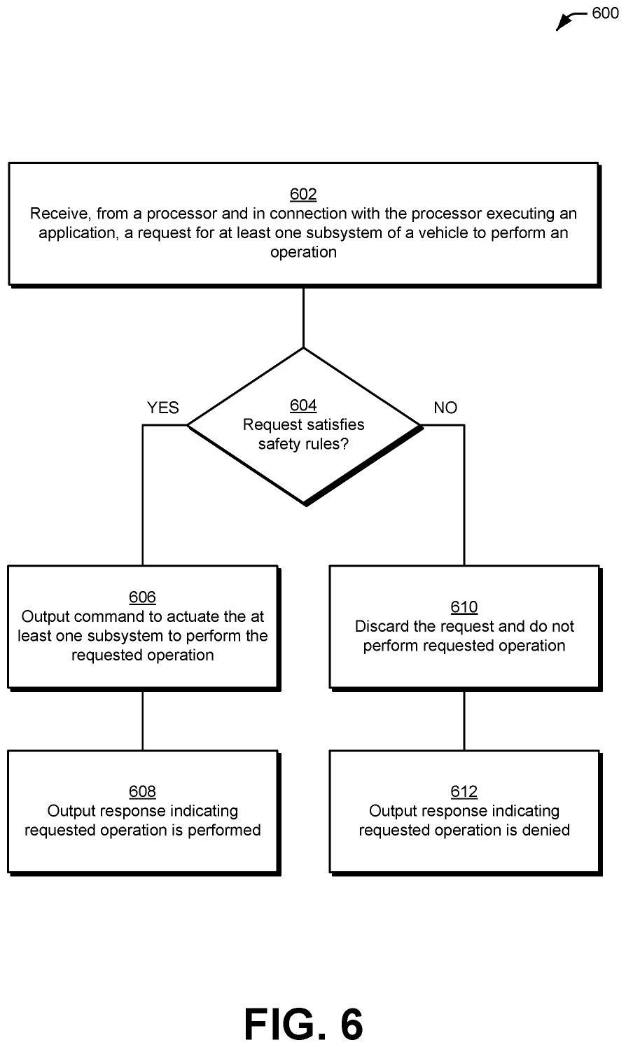

FIG. 6 depicts a procedure in an example 600 implementation of custom application systems for safe vehicle operation.

A request for at least one subsystem of a vehicle to perform an operation is received from a processor in connection with the processor executing an application (block 602). By way of example, the safety processor(s) 108 receives the request 122 from the partitioned application processor 110 over a connection between the safety processor(s) 108 and the partitioned application processor 110. The request 122 is received in connection with the partitioned application processor 110 executing an application(s) 112. Further, the request 122 includes an operation to be performed by at least one vehicle subsystem (not shown) capable of being actuated by a vehicle subsystem actuator 106.

A determination is made regarding whether the request satisfies safety rules (block 604). By way of example, the custom application API 116 provided by the safety processor(s) 108 determines whether the request 122 satisfies the safety rules 120, which if satisfied maintain the integrity of a safety standard for the vehicle 102, such as ASIL-D integrity.

If it is determined that the request satisfies the safety rules (e.g., “YES” at block 604), then a command is output to actuate the at least one subsystem to perform the requested operation (block 606). In one or more implementations, a response is output indicating the requested operation is performed (block 608). By way of example, if the custom application API 116 determines at block 604 that the request 122 satisfies the safety rules 120, then the safety processor(s) 108 outputs a command 118, which is sent to the targeted vehicle subsystem actuator 106 to actuate the respective vehicle subsystem to perform the requested operation. Additionally, the safety processor processor(s) 108 outputs the response 124 to the partitioned application processor 110 executing the application(s) 112, and the response 124 indicates that the requested operation is performed.

If it is determined that the request does not satisfy the safety rules (e.g., “NO” at block 604), then the requested operation is not performed (block 610). Alternatively or additionally, the request is discarded. In one or more implementations, a response is output indicating the requested operation is denied (block 612). By way of example, if the custom application API 116 determines at block 604 that the request 122 does not satisfy the safety rules 120, then the safety processor(s) 108 does not cause the operation to be performed. For instance, the safety processor(s) 108 does not send a command to a vehicle subsystem actuator 106 regarding the requested operation. In one or more implementations, the safety processor(s) 108 also discards the request 122. In at least one variation, the safety processor processor(s) 108 outputs the response 124 to the partitioned application processor 110 executing the application(s) 112, and the response 124 indicates that the requested operation is denied.

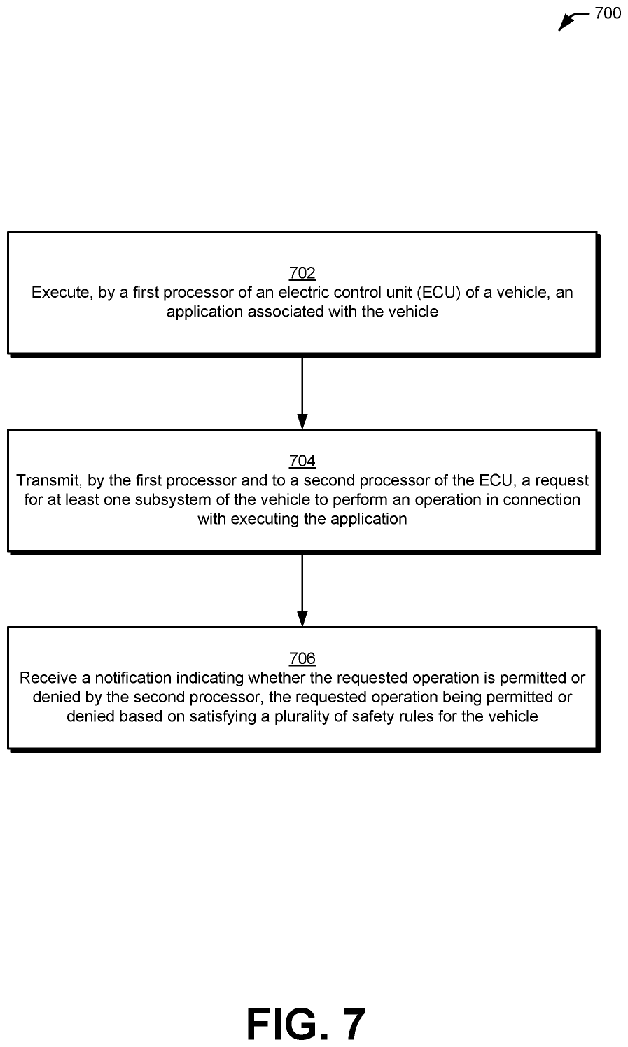

FIG. 7 depicts another procedure in an example 700 implementation of custom application systems for safe vehicle operation.

An application associated with a vehicle is executed by a first processor of an electric control unit (ECU) of the vehicle (block 702). By way of example, the application(s) 112 is executed by the partitioned application processor 110 of the central control unit 104 of the vehicle 102.

A request for at least one subsystem of the vehicle to perform an operation in connection with executing the application is transmitted by the first processor to a second processor of the ECU (block 704). By way of example, the request 122 requests that at least one subsystem of the vehicle 102 perform an operation in connection with the execution of the application(s) 112 at block 702. Further, the request 122 is transmitted by the partitioned application processor 110 to the safety processor(s) 108 of the central control unit 104.

A notification indicating whether the requested operation is permitted or denied is received by the first processor (block 706). In accordance with the principles discussed herein, whether the requested operation is permitted or denied is based on satisfying a plurality of safety rules for the vehicle 102. The partitioned application processor 110 receives the response 124 from the safety processor(s) 108, and the response 124 indicates whether the request 122 transmitted at block 704 was permitted based on satisfying the safety rules 120 or denied based on failing to satisfy the safety rules 120.

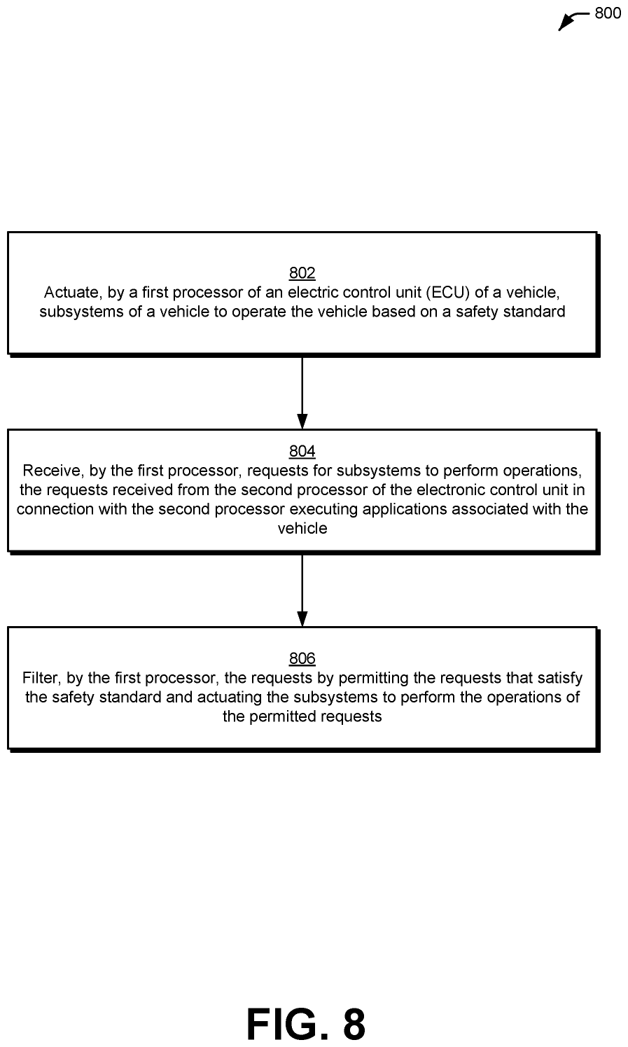

FIG. 8 depicts another procedure in an example 800 implementation of custom application systems for safe vehicle operation.

Subsystems of a vehicle are actuated, by a first processor of an electronic control unit, to operate the vehicle based on a safety standard (block 802). By way of example, the safety processor(s) 108 actuates the subsystems of the vehicle 102 via the plurality of vehicle subsystem actuators 106 to operate the vehicle 102 based on a safety standard, such as ASIL-D. For instance, the safety processor(s) 108 actuates the subsystems to control motion of the vehicle 102.

Requests are received, by the first processor, for the subsystems to perform operations (block 804). In accordance with the principles discussed herein, the requests are received from a second processor of the electronic control unit in connection with the second processor executing applications associated with the vehicle. By way of example, the safety processor(s) 108 receives the request 122 in connection with the partitioned application processor 110 executing the application(s) 112.

The requests are filtered, by the first processor, by permitting the requests that satisfy the safety standard and by actuating the subsystems to perform the operations of the permitted requests (block 806). By way of example, the processor(s) 108 filters the request 122 by permitting the request 122 if it satisfies the safety rules 120 (e.g., corresponding to the safety standard) and actuating the respective subsystem to perform the requested operation.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include read only memory (ROM), random-access memory (RAM), a register, cache memory, semiconductor memory devices, magnetic media such as internal hard disks and removable disks, and magneto-optical media.

What is claimed is:

1. A system comprising:
one or more subsystems of a vehicle, each of the one or more subsystems configured to perform an operation of the vehicle; and
a central control unit of the vehicle, the central control unit comprising:
a first processor configured to execute applications associated with the vehicle; and
a second processor configured to maintain an operating state of the vehicle within a safe operating envelope of the vehicle, wherein the second processor receives requests from the applications executed by the first processor to perform operations and outputs commands to actuate the one or more subsystems of the vehicle to perform the operations based on the requests satisfying safety rules for the vehicle.

2. The system of claim 1, wherein the second processor prevents requests for operations that fail to satisfy the safety rules from being communicated to the one or more subsystems of the vehicle.

3. The system of claim 1, wherein the second processor provides an application programming interface for the applications which prevents access by the applications to the one or more subsystems unless the requests satisfy the safety rules.

4. The system of claim 1, wherein the first processor is partitioned from the second processor such that the second processor maintains safe operation of the vehicle when execution of the applications by the first processor causes a malfunction with the first processor.

5. The system of claim 1, wherein the central control unit further comprises a third processor configured to operate redundantly with the second processor to maintain the operating state of the vehicle within the safe operating envelope of the vehicle.

6. The system of claim 5, wherein:
the third processor is configured to maintain the operating state of the vehicle within the safe operating envelope of the vehicle when a malfunction occurs with the second processor; and
the second processor is configured to maintain the operating state of the vehicle within the safe operating envelope of the vehicle when a malfunction occurs with the third processor.

7. The system of claim 1, wherein satisfying the safety rules comprises satisfying Automotive Safety Integrity Level D (ASIL-D) operation of the vehicle.

8. An electronic control unit for controlling operation of a vehicle, the electronic control unit comprising:
a first processor configured to execute applications associated with the vehicle; and
a second processor communicably coupled to the first processor, the second processor configured to:
actuate subsystems of the vehicle to operate the vehicle based on a safety standard;
receive requests for the subsystems to perform operations from the first processor, the requests received in connection with executing the applications; and
filter the requests by permitting the requests that satisfy the safety standard and actuating the subsystems to perform the operations of the permitted requests.

9. The electronic control unit of claim 8, wherein the second processor is further configured to filter the requests by denying the requests that fail to satisfy the safety standard.

10. The electronic control unit of claim 9, wherein the second processor does not actuate the subsystems to perform the operations of the denied requests.

11. The electronic control unit of claim 8, wherein the first processor is physically partitioned from the subsystems of the vehicle and the requests for the subsystems to perform the operations from the first processor are routed to the second processor via a communicative coupling.

12. The electronic control unit of claim 8, wherein the second processor is configured to actuate the subsystems of the vehicle to control motion of the vehicle based on the safety standard.

13. The electronic control unit of claim 8, further comprising a third processor communicably coupled to the first processor, the third processor configured, redundantly with the second processor, to:
actuate the subsystems of the vehicle to operate the vehicle based on the safety standard;
receive the requests for the subsystems to perform the operations from the first processor; and
filter the requests by permitting the requests that satisfy the safety standard and actuating the subsystems to perform the operations of the permitted requests.

14. The electronic control unit of claim 13, wherein the first processor is physically partitioned from the subsystems of the vehicle and the requests for the subsystems to perform the operations from the first processor are routed to only the second processor and the third processor via communicative couplings.

15. The electronic control unit of claim 8, wherein the safety standard is Automotive Safety Integrity Level D (ASIL-D).

16. The electronic control unit of claim 8, wherein the first processor is partitioned from the second processor such that the applications are limited to being executed by the first processor.

17. The electronic control unit of claim 8, wherein the second processor includes one or more I/O ports for at least one of communicative couplings with the subsystems of the vehicle, control signals with the subsystems of the vehicle, or I/O signals with the subsystems of the vehicle.

18. The electronic control unit of claim 8, wherein the first processor includes a memory, the second processor includes a memory, the memory of the first processor is isolated from the memory of the second processor, and the first processor is further configured to execute the applications using only the memory of the first processor.

19. The electronic control unit of claim 18, wherein the applications are prevented from using at least one of the memory of the second processor or peripheral signal I/O of the second processor.

20. A method implemented by an electronic control unit for controlling operation of a vehicle, the method comprising:
actuating, by a first processor of an electronic control unit, subsystems of a vehicle to operate the vehicle based on a safety standard;
receiving, by the first processor, requests for the subsystems to perform operations, the requests received from a second processor of the electronic control unit in connection with the second processor executing applications associated with the vehicle; and
filtering, by the first processor, the requests by permitting the requests that satisfy the safety standard and actuating the subsystems to perform the operations of the permitted requests.
